(19) United States
(12) Patent Application Publication
(10) Pub. No.: US 2019/0070054 A1
(43) Pub. Date: Mar. 7, 2019

(54) SUBJECT TRANSFER APPARATUS

(71) Applicant: Hill-Rom Services, Inc., Batesville, IN (US)

(72) Inventors: Keng Hoe Tee, Singapore (SG); Bobby Gee Han Png, Singapore (SG); Yong Sern Gwee, Singapore (SG)

(73) Assignee: Hill-Rom Services, Inc., Batesville, IN (US)

(21) Appl. No.: 16/111,876

(22) Filed: Aug. 24, 2018

Related U.S. Application Data
(60) Provisional application No. 62/555,299, filed on Sep. 7, 2017.

(51) Int. Cl. A61G 7/10

(52) U.S. Cl. CPC A61G 7/1046; A61G 7/1038; A61G 2200/32; A61G 7/103; A61G 7/1084; A61G 7/1096

(57) ABSTRACT

Embodiments described herein provide a subject transfer apparatus including a base unit comprising a lifting mechanism, a body unit coupled to the lifting mechanism, a subject support platform coupled to the body unit, and a slide assembly coupling the subject support platform to the base unit such that the subject support platform is slidable between a first position in which the subject support platform positioned over the base unit and a second position in which the subject support platform is cantilevered from the base unit. The subject support platform includes a first extension platform and a second extension platform slidably disposed within the subject support platform. In various embodiments, the first extension platform and the second extension platform are extendable away from the subject support platform opposite one another. Methods of transferring a subject using the subject transfer apparatus are also described.

### CROSS-REFERENCE TO RELATED APPLICATIONS

This application claims priority to U.S. Provisional Application No. 62/555,299 filed on Sep. 7, 2017, the entire contents of which are incorporated by reference herein.

### TECHNICAL FIELD

The present specification generally relates to subject transfer apparatuses, and more specifically, to subject transfer apparatuses for use in transferring subjects from person support surfaces.

### BACKGROUND

Conventionally, transferring a subject from one support apparatus to another, such as from a bed to a wheelchair, requires a substantial amount of physical effort by a caregiver. Additionally, such caregivers may require extensive training and may be required to be in close bodily contact with the transfer subject, which can make the caregiver and/or the subject uncomfortable.

Accordingly, a need exists for subject transfer apparatuses which reduce the physical effort on the part of a caregiver.

### SUMMARY

In various embodiments, a subject transfer apparatus includes a base unit comprising a lifting mechanism, a body unit coupled to the lifting mechanism, a subject support platform coupled to the body unit, and a slide assembly coupling the subject support platform to the base unit such that the subject support platform is slidable between a first position in which the subject support platform positioned over the base unit and a second position in which the subject support platform is cantilevered from the base unit. The subject support platform includes a first extension platform and a second extension platform slidably disposed within the subject support platform. In various embodiments, the first extension platform and the second extension platform are extendable away from the subject support platform opposite from one another.

In various embodiments, a method of transferring a subject includes positioning a subject transfer apparatus adjacent to a subject support apparatus upon which the subject is disposed. The subject transfer apparatus includes a base unit comprising a lifting mechanism, a body unit coupled to the lifting mechanism, a subject support platform coupled to the body unit, and a slide assembly coupling the subject support platform to the base unit such that the subject support platform is slidable between a first position in which the subject support platform is positioned over the base unit and a second position in which the subject support platform is cantilevered from the base unit. The subject support platform includes a first extension platform and a second extension platform slidably disposed within the subject support platform, the first extension platform and the second extension platform extendable away from the subject support platform opposite from one another. The method further includes adjusting a height of the subject support platform using the lifting mechanism such that the subject support platform may be slid along a top surface of the subject support apparatus; moving the subject support platform from the first position to the second position, wherein when in the second position, the subject support platform is disposed between the subject and the subject support apparatus; extending the first extension platform and the second extension platform away from the subject support platform; and moving the subject support platform from the second position to the first position with the subject disposed thereon.

In various embodiments, a subject transfer apparatus includes a base unit comprising a lifting mechanism, a body unit coupled to the lifting mechanism, a subject support platform coupled to the body unit providing a substantially continuous support surface along a length of the subject support platform and a width of the subject support platform, and a slide assembly coupling the subject support platform to the base unit such that the subject support platform is slidable between a first position in which the subject support platform positioned over the base unit and a second position in which the subject support platform is cantilevered from the base unit. The subject support platform includes a first extension platform and a second extension platform slidably disposed within the subject support platform. In various embodiments, the first extension platform and the second extension platform are extendable away from the subject support platform opposite from one another and are each rotatable with respect to the subject support platform.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

Referring now to the illustrative examples in the drawings, wherein like numerals represent the same or similar elements throughout:

FIG. 1 schematically depicts a subject transfer apparatus for use in transferring a subject from a person support apparatus in accordance with one or more embodiments;

FIG. 2 is a perspective view of a subject transfer apparatus in which the subject support platform is in a first position in accordance with one or more embodiments;

FIG. 3 is a perspective view of a subject transfer apparatus in which the subject support platform is in a second position in accordance with one or more embodiments;

FIG. 4 is a side view of a subject transfer apparatus in which the subject support platform is in a second position in accordance with one or more embodiments;

FIG. 5 is a perspective view of a subject transfer apparatus having first and second extension platforms extended from the subject support platform in accordance with one or more embodiments;

FIG. 6 is a perspective view of a subject transfer apparatus in which the first and second extension platforms are rotated into a chair configuration in accordance with one or more embodiments;

FIG. 7 schematically depicts a subject transfer apparatus in a lowered configuration relative to a person support apparatus in accordance with one or more embodiments;

FIG. 8 schematically depicts a subject transfer apparatus in a raised configuration relative to a person support apparatus in accordance with one or more embodiments;

FIG. 9 schematically depicts a subject transfer apparatus having the subject support platform positioned between a subject and the person support apparatus in accordance with one or more embodiments;

FIG. 10 schematically depicts a subject transfer apparatus having a subject positioned thereon and having the first and second extension platforms extended from the subject support platform in accordance with one or more embodiments; and

FIG. 11 schematically depicts a subject transfer apparatus having a subject positioned thereon and in which the first and second extension platforms are rotated into a chair configuration in accordance with one or more embodiments.

### DETAILED DESCRIPTION

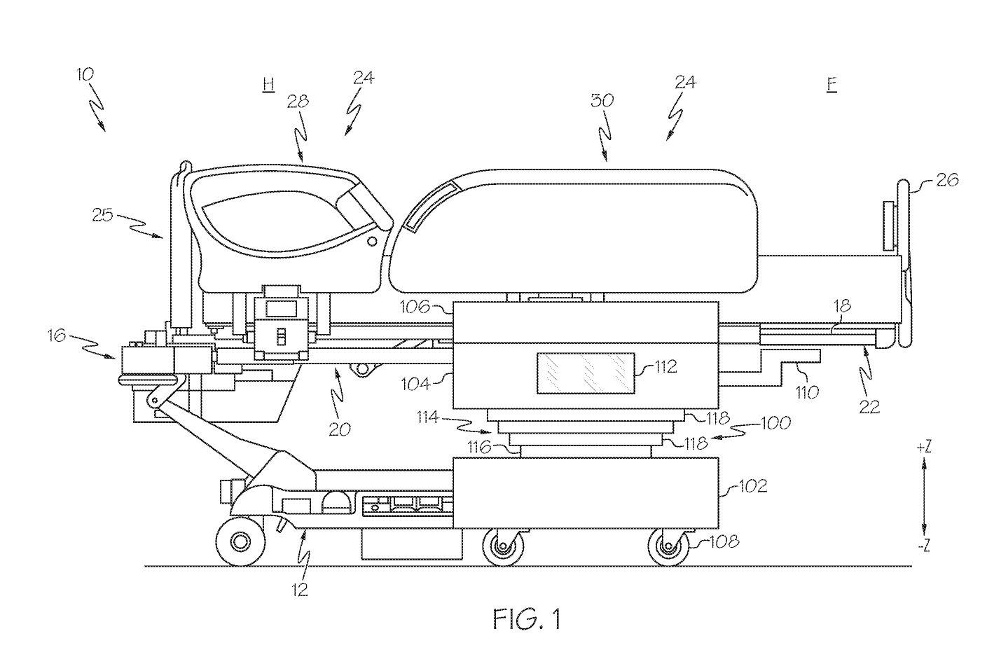

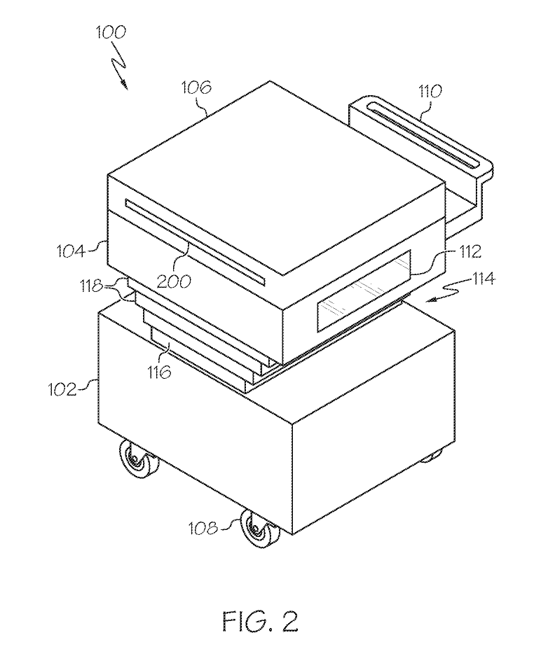

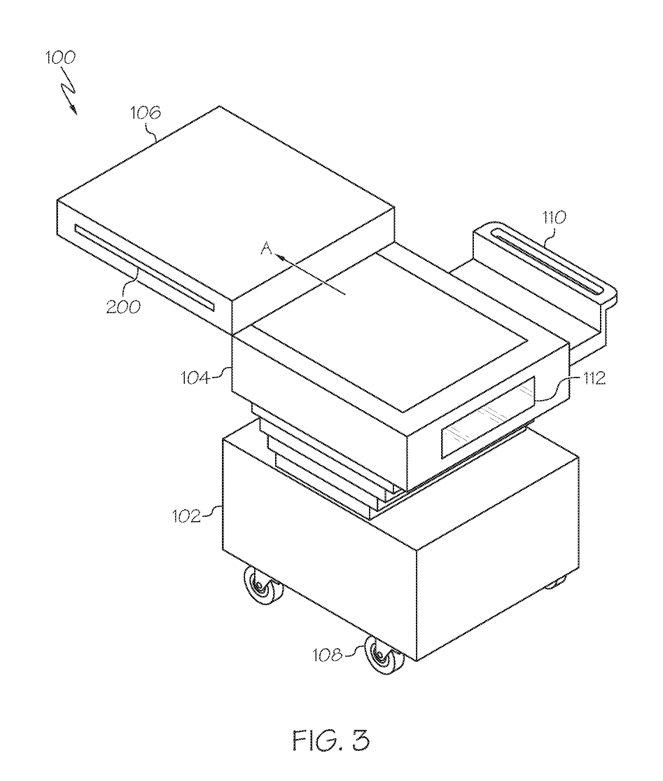

Various embodiments described herein include a subject transfer apparatus for use in transferring a subject, such as a patient, from one support surface to another support surface. For example, in FIG. 1, the subject transfer apparatus 100 may be used to transfer a subject from a person support apparatus 10 to another support surface not shown in FIG. 1. In various embodiments provided herein, the subject transfer apparatus 100 may include a base unit comprising a lifting mechanism, a body unit coupled to the lifting mechanism, and a subject support platform coupled to the body unit. The subject transfer apparatus 100 may further include a slide assembly coupling the subject support platform to the base unit such that the subject support platform is slidable between a first position (as shown in FIGS. 1 and 2) and a second position (as shown in FIG. 3). Accordingly, when the subject transfer apparatus 100 is positioned adjacent to a person support apparatus 10, the subject support platform may be moved from the first position to the second position, in which the subject support platform is disposed between the subject and the person support apparatus 10. When the subject support platform is returned to the first position, the subject may be transported with the subject support platform, transferring the subject from the person support apparatus 10, as will be described in greater detail below.

A person support apparatus 10 according to various embodiments is depicted in FIG. 1. The person support apparatus 10 can be, for example, a hospital bed, a stretcher, a patient lift, a chair, an operating table, or similar support apparatuses commonly found in hospitals, nursing homes, rehabilitation centers, or the like. As shown in FIG. 1, the person support apparatus includes a lower frame 12 and an upper frame 16 movably supported by a plurality of lift members (not shown) above the lower frame 12. In various embodiments, the person support apparatus 10 includes a support surface 18 that is supported by the upper frame 16. The support surface 18 has a first section, designated as a head end H, and a second section, designated as a foot end F. The support surface 18 may be, for example, a deck 22.

In embodiments, the upper frame 16 can include an upper frame base 20 which supports the deck 22. The person support apparatus 10 may further include side rails 24, a headboard 25, and a footboard 26. The side rails 24, headboard 25, and footboard 26 are supported by the upper frame 16, as shown in FIG. 1. The side rails 24, the headboard 25, and the footboard 26 are affixed to the upper frame 16 such that they generally define the perimeter edge of the upper frame 16. In some embodiments, the side rails 24 may include multiple sections. For example, in some embodiments, the side rails 24 may each include a head side rail 28, located adjacent to the head end H of the support surface 18, and an intermediate side rail 30 positioned between the head side rail 28 and the foot end F.

FIG. 1 further depicts a subject transfer apparatus 100 positioned adjacent to the person support apparatus 10. As shown in FIG. 1, the subject transfer apparatus 100 generally includes a base unit 102, a body unit 104 positioned above the base unit 102, and a subject support platform 106 that is movable with respect to the body unit 104. The subject transfer apparatus 100 of FIG. 1 further includes wheels 108 (one pair depicted in FIG. 1), a handle 110, and a display 112 coupled to a control system.

In various embodiments, the base unit 102 houses a battery and a lifting mechanism (not shown) which is coupled to the body unit 104 and configured to raise and lower the body unit 104 with respect to the base unit 102. The battery may be, for example, a rechargeable lithium ion battery that is configured to be used with the subject transfer apparatus 100. Although various embodiments include a single battery, it is contemplated that multiple batteries may be used to provide power to the lifting mechanism, the display 112 and control system, and/or any other powered components, as will be described herein. For example, the battery may be configured to provide power to the lifting mechanism, various slide assemblies, wheels, and other powered components included in the subject transfer apparatus 100. In embodiments in which the battery is rechargeable, it may be connected to a power source while in position within the base unit 102, or it may be removed from the base unit 102 for charging.

The lifting mechanism may be any type of lifting mechanism suitable to raise and lower the body unit 104 and the subject support platform 106 with respect to the base unit 102. For example, the lifting mechanism may include a hydraulic, pneumatic, electro-mechanical, or mechanical lifting mechanism. In embodiments where the lifting mechanism is electro-mechanical, the lifting mechanism may comprise, for example and without limitation, a linear actuator or another, similar electromechanical actuator routinely employed in medical equipment such as patient lifts or the like. In various embodiments, the lifting mechanism may be coupled to the battery, which powers the lifting mechanism. Additionally, the lifting mechanism may be coupled to the control system, which is configured to actuate the lifting mechanism thereby raising or lowering the lifting mechanism in response to a received user input.

In some particular embodiments, the lifting mechanism may be in the form of a telescoping column 114 as depicted in FIG. 1. The telescoping column 114 is positioned on and supported by the base unit 102. The body unit 104 is positioned on and supported by the telescoping column 114. The telescoping column 114 includes an adjustment system (not shown) for raising and lowering the body unit 104 and the subject support platform 106 relative to the base unit 102 and/or tilting the body unit 104 relative to the base unit 102. In embodiments, the adjustment system may be a mechanical adjustment system, an electro-mechanical adjustment system, a hydraulic adjustment system, or combinations thereof. For example, the adjustment system may include a spindle mechanism that is driven by an electric motor for raising and lowering the telescoping column. The adjustment system may be positioned within the telescoping column 114.

To facilitate vertically raising and lowering the body unit 104 and the subject support platform 106 relative to the base unit 102, the telescoping column 114 includes a base support 116 coupled to the base unit 102 and a plurality of nestable cassettes 118 extending between the base support 116 and the body unit 104. The base support 116 and the plurality of nestable cassettes 118 form a cladding (i.e., the exterior surface) of the telescoping column 114. The cladding encloses and conceals the adjustment system of the subject transfer apparatus 100. In embodiments, the cladding may be made from, for example, stainless steel or other suitable material capable of being washed and sterilized.

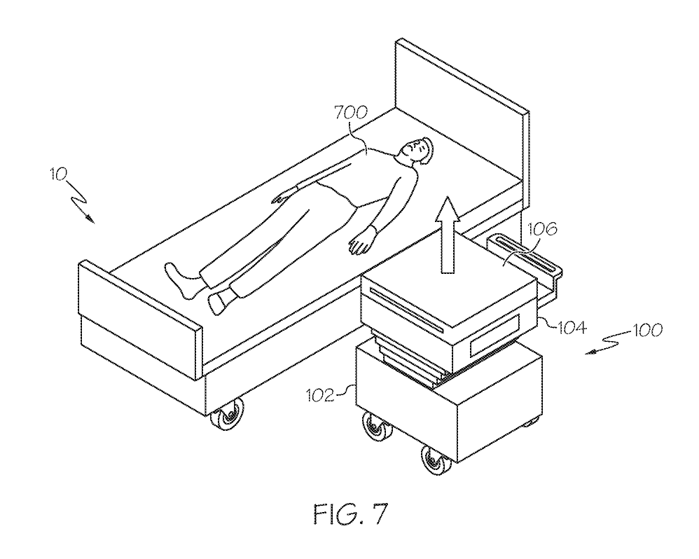

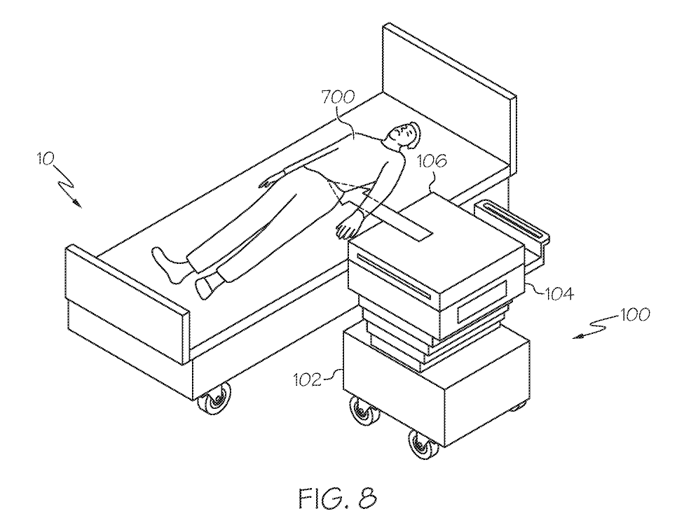

The plurality of nestable cassettes 118 are supported on the base support 116 and are actuatable, such as with the adjustment system, to extend and retract in a vertical direction relative to the base support 116. For example, a base cassette is directly engaged with the base support 116 and is configured to slide over a perimeter of the base support 116 in a +Z direction when the telescoping column 114 is transitioning to an extended position, as illustrated in FIG. 8, and in a −Z direction when the telescoping column 114 is transitioning to a retracted position, as illustrated in FIG. 7. An intermediate cassette may be directly engaged with the base cassette and is configured to slide over a perimeter of the base cassette in a +Z direction when the telescoping column 114 is transitioning to an extended position, as illustrated in FIG. 8, and in a −Z direction when the telescoping column 114 is transitioning to a retracted position, as illustrated in FIG. 7. Subsequent intermediate cassettes may be similarly engaged with each preceding cassette until a master cassette is reached. In this way, each consecutive cassette of the plurality of nestable cassettes 118 may have a greater perimeter compared to the immediately preceding cassette.

A master cassette may be the last cassette of the plurality of nestable cassettes 118, and may have the largest perimeter of the plurality of cassettes 118. The master cassette may similarly be engaged with and move relative to an immediately preceding intermediate cassette as described above with respect to the base cassette and the first intermediate cassette. For example, the master cassette is coupled to the underside of the body unit 104 and is directly engaged with an immediately preceding intermediate cassette and is configured to slide over an outer surface of the immediately preceding intermediate cassette in a +Z direction when the telescoping column 114 is transitioning to an extended position, as illustrated in FIG. 8, and in a −Z direction when the telescoping column 114 is transitioning to a retracted position, as illustrated in FIG. 7. Accordingly, it should be understood that, when the telescoping column 114 is in the retracted position, the base cassette is nested within the intermediate cassette, and so forth.

Each cassette of the plurality of nestable cassettes 118 may be coupled with the immediately preceding cassette through a variety of conventional coupling techniques including, but not limited to, interference structures, hooks, pins, and the like. For example and without limitation, in one embodiment, the intermediate cassette may contain a flange (not shown) that extends from the top edge of the intermediate cassette inward, towards the center of the telescoping column 114. The next intermediate cassette may have a corresponding flange (not shown) that extends from the bottom edge of the intermediate cassette outward, away from the center of the telescoping column 114. The intermediate cassette and the preceding intermediate cassette may also be coupled to the adjustment system such that the intermediate cassette and the preceding intermediate cassette are raised or lowered with the body unit 104. As the body unit 104 is raised, for example, the flange of the intermediate cassette engages with the corresponding flange of the next intermediate cassette 117, drawing the intermediate cassette over the base cassette. Each adjacent pair of adjacent cassettes in the plurality of nestable cassettes 118 may be similarly coupled to facilitate the “telescoping” effect of the telescoping column 114.

This telescoping effect is also enabled by the relative dimensions of each of the cassettes of the plurality of nestable cassettes 118. As noted above, a perimeter of each consecutive nestable cassette of the plurality of nestable cassettes 118 may increase from the base support 116 in the +Z direction as indicated in FIG. 1. As such, the master cassette may define a largest perimeter of the plurality of nestable cassettes 118.

In some embodiments, the telescoping column may be inverted relative to the telescoping column described hereinabove. In other words, in some embodiments, the master cassette (e.g., the cassette with the largest perimeter of the plurality of nestable cassettes 118) may be positioned in the −Z direction relative to each of the other cassettes in the plurality of nestable cassettes when the telescoping column is extended.

Although various embodiments described herein include an automated lifting mechanism, it is contemplated that in some embodiments, the lifting mechanism may be actuated manually. For example, the lifting mechanism may include a scissor lift type mechanism that is raised or lowered in response to a force applied by a user, such as a caregiver. Although such embodiments may reduce a cost associated with the lifting mechanism and the subject transfer apparatus 100, additional user effort may be required as compared to embodiments including automated lifting mechanisms.

The base unit 102 may be configured to act as a counterweight when the subject support platform 106 is shifted horizontally with respect to the base unit 102, as shown in FIGS. 3-5. For example, the weight associated with the base unit 102, attributable to at least the battery and lifting mechanism housed therein, may be sufficient to prevent the subject transfer apparatus 100 from tipping over when a subject is supported by the subject support platform 106. However, in some embodiments, additional weights may be provided within the base unit 102 to enable the base unit 102 to function as a counterweight.

The body unit 104 is coupled to the lifting mechanism and is generally positioned over the base unit 102. Accordingly, when the lifting mechanism is actuated, the body unit 104 is raised or lowered with respect to the base unit 102. As depicted in FIG. 1, the body unit 104 includes the display 112. The body unit 104 may further include at least part of a slide assembly configured to enable the subject support platform 106 to be shifted (e.g., slid) between a first position and a second position, as will be described in greater detail below.

In various embodiments, the body unit 104 further comprises a handle 110. The handle 110 may enable a user, such as a caregiver, to maneuver, stabilize, or otherwise interact with the subject transfer apparatus 100. For example, the user may grip the handle 110 to pull or push the subject transfer apparatus 100 into position relative to the person support apparatus 10.

In embodiments, the display 112 housed in the body unit 104 may be, for example, a touch screen display or the like comprising a plurality of programmable buttons which facilitate operation of the subject transfer apparatus 100 through user inputs. In embodiments, the display 112 is coupled to a control system configured to cause the subject transfer apparatus 100 to perform various functions. In some contemplated embodiments, the control system controls the operation of the lifting mechanism, various slide assemblies, wheels, and other features of the subject transfer apparatus 100.

The control system includes a controller, the display 112, and one or more user input devices. The controller receives signals from the one or more user input devices and adjusts one or more features of the subject transfer apparatus 100 in response to those signals. In various embodiments, the controller may be any type of computing device, which generally includes at least a processor and a non-transitory memory component for storing one or more computer readable instructions that are executable by the processor. The controller may be coupled to the lifting mechanism, various slide assemblies, wheels, and/or other features of the subject transfer apparatus 100 via wires or wirelessly, through networking hardware.

The one or more user input devices may include buttons positioned on the body unit 104 or the handle 110, touchscreen functionality on the display 112, or a pendant or remote control (not depicted) configured to receive input from a user, such as a caregiver, to enable the user to interact with the subject transfer apparatus 100.

The controller may provide an output that is displayed on a graphical user interface (GUI) via the display 112, such as to indicate a position of the subject support platform 106 relative to the body unit 104, information regarding the substantially horizontal position or chair configuration of the subject transfer apparatus 100, a tilt of the body unit 104, or the like. The controller may further provide outputs via the display 112 regarding warnings or instructions for a user, such as an order in which to move the various components of the subject transfer apparatus 100 to achieve a particular configuration.

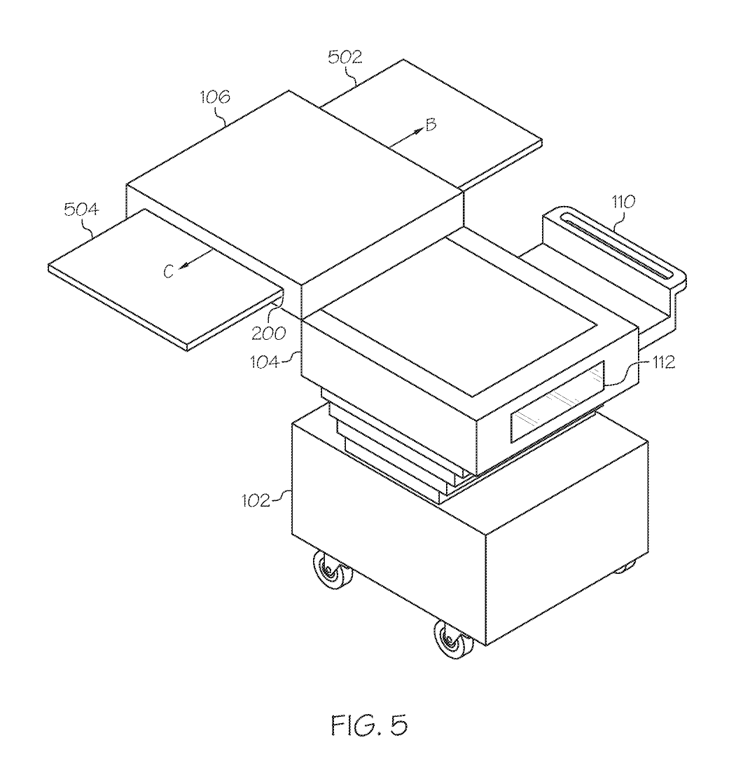

The subject support platform 106 is coupled to the body unit 104 and includes a first extension platform 502 (shown in FIG. 5) and a second extension platform 504 (shown in FIG. 5) slidably disposed therein. As shown in FIG. 2, the subject support platform 106 includes a slot 200 disposed therein through which the extension platform passes. In embodiments in which the subject support platform 106 includes first and second extension platforms disposed therein, the subject support platform 106 may include two slots, one positioned along each of a pair of opposing sides of the subject support platform 106. In various embodiments, the subject support platform 106 provides a substantially continuous support surface along a length of the subject support platform 106 and along a width of the subject support platform 106. In other words, the subject support platform 106 may provide support to a subject along its entire length and width, without any gaps or breaks in the support surface.

The subject support platform 106 may be made of any suitable material. The subject support platform 106 may generally include a ticking covering a support cushion and a rigid backing. In various embodiments, the ticking is made of a wipeable material, such as nylon coated with polyurethane. Other materials may be used depending on the particular embodiment. For example, materials selected for use may be moisture and vapor permeable but liquid impermeable to allow the material to wick moisture away from the skin of the subject being transferred using the subject transfer apparatus 100. In various embodiments, the ticking is a low friction, air permeable material (such as spandex, nylon, or similar materials) that allows the ticking to move in response to the motion of a subject on the subject support platform 106 in order to reduce shear forces, for instance. In other embodiments, the ticking is made of a non-air permeable, moisture/vapor permeable material such as Teflon or urethane-coated fabric. In various embodiments, the ticking forms a subject support surface and a bottom surface.

The support cushion may be a foam or other cushioning material that provides support to a subject positioned on the subject support platform 106. In various embodiments, the support cushion may be positioned between the subject support surface and the rigid backing.

The rigid backing may be any suitable type of rigid material that provides structure and support to a subject positioned on the subject support platform 106. For example, the rigid backing may be a metal or strong, rigid plastic or composite material that is capable of supporting the weight of a subject when the subject support platform 106 is cantilevered from the body unit 104. In various embodiments, the rigid backing may be positioned between the support cushion and the bottom surface of the subject support platform 106.

The slot 200 may be formed through the side of the subject support platform 106 in any suitable manner. For example, the rigid backing may be multi-layered and the layers of the rigid backing may define a cavity between adjacent layers that may receive the extension platforms when they are disposed within the subject support platform 106. In such embodiments, the slot 200 may be an open end on the subject support platform 106 between the layers of the rigid backing. Alternatively, the slot 200 may a cavity formed in the support cushion of the subject support platform 106 to enable the first and second extension platforms to be disposed within the subject support platform 106. The first and second extension platforms will be described in greater detail below.

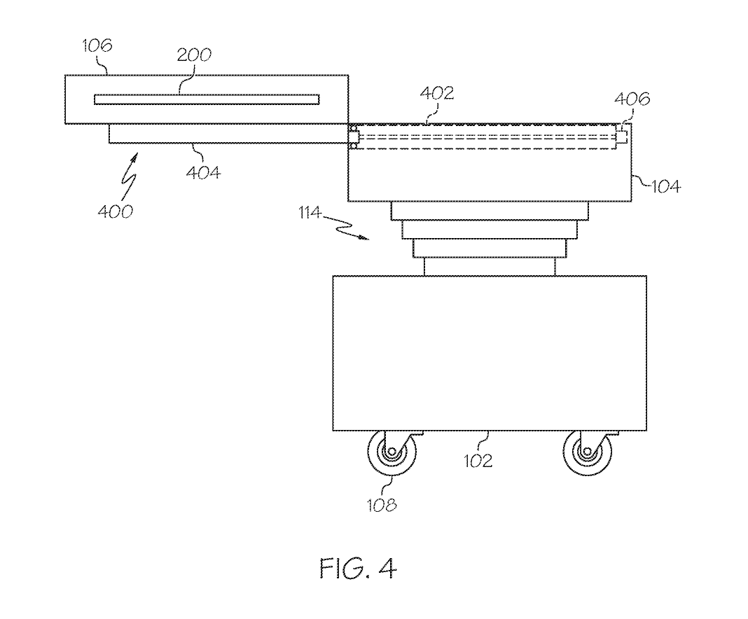

As noted herein, the subject support platform 106 is slidable between a first position in which the subject support platform 106 is positioned over the base unit 102 (as shown in FIGS. 1 and 2) and a second position in which the subject support platform 106 is cantilevered from the base unit 102 (as shown in FIGS. 3-5). As shown in FIG. 3, the subject support platform 106 slides in the direction of arrow A to shift from the first position to the second position. In various embodiments, the subject transfer apparatus 100 includes a slide assembly 400 (shown in FIG. 4) coupling the subject support platform 106 to the base unit 102 such that the subject support platform 106 is slidable between the first position and the second position.

In the embodiment depicted in FIG. 4, the slide assembly 400 includes one or more rails 402 along which a bearing 404 coupled to the subject support platform 106 is slidable. As shown in FIG. 4, the bearing 404 is mounted to the bottom surface of the subject support platform 106, although it is contemplated that the bearing 404 may be coupled to the subject support platform 106 in another way, depending on the particular embodiment employed. For example, the bearing 404 may be mounted to the side of the subject support platform 106, parallel to the slot 200. Moreover, although FIG. 4 depicts a single bearing 404, it is contemplated that multiple bearings, such as a bearing on or proximate to each side of the subject support platform 106 may be employed.

The rail 402 in FIG. 4 is depicted as being coupled to the body unit 104 by being mounted to an inside surface of the body unit 104. For example, the rail 402 may be mounted to a housing around the body unit 104. Alternatively, the rail 402 may be mounted to a top surface of the body unit 104 and the corresponding bearing 404 may be mounted to the bottom surface of the subject support platform 106. It is contemplated that the rail 402 may be otherwise mounted to the body unit 104 provided that it is positioned such that the bearing 404 may slide along the rail 402.

In some embodiments, such as the embodiment depicted in FIG. 4, the slide assembly 400 further includes an actuator 406 coupled to the bearing 404 to drive the bearing 404 along the rail 402. The actuator 406 may be a powered actuator, such as an electric motor, linear actuator, or the like, or may be manually powered, such as by a system of gears actuated by a pedal, a crank, or the like. The actuator 406 may be, for example, a linear actuator, a hydraulic actuator, a pneumatic actuator, an electro-mechanical actuator, or the like. In some embodiments, the actuator 406 may be coupled to the control system such that the control system may actuate the actuator 406 to drive the bearing 404 along the rail 402.

Turning now to FIG. 5, the first extension platform 502 and the second extension platform 504 may be extended from the subject support platform 106 to provide additional support to a subject disposed thereon. For example, when the subject transfer apparatus 100 is used to transfer a subject, the subject support platform 106 may be positioned such that it supports the lower back, buttocks, and upper legs of a subject. Accordingly, the first extension platform 502 may be extended from the subject support platform 106 to provide support to the upper back, shoulders, and head of the subject, while the second extension platform 504 may be extended from the subject support platform 106 to provide support to the lower legs and feet of the subject.

In various embodiments, the first extension platform 502 is extendable from the subject support platform 106 in a first direction indicated by arrow B in FIG. 5. The second extension platform 504 is extendable from the subject support platform 106 in a second direction that is opposite the first direction, as indicated by arrow C in FIG. 5. In embodiments, the subject support platform 106 is cantilevered from the base unit 102 in a direction orthogonal to the direction in which the first extension platform 502 (and/or the second extension platform 504) is extended from the subject support platform 106.

As described above, the first extension platform 502 and the second extension platform 504 are slidably disposed within the subject support platform 106. Accordingly, each of the first and second extension platforms is coupled to a slide assembly (not shown) which enables the extension platform to be extended or retracted relative to the subject support platform 106. The slide assembly may be in the form of one or more rails mounted within the subject support platform 106 and a corresponding bearing coupled to the extension platform, as described hereinabove with respect to slide assembly 400. Alternatively, other slide assembly configurations may be employed, depending on the particular embodiment. Additionally, like the slide assembly 400, in some embodiments, the slide assembly coupled to each extension platform may include an actuator for actively driving the extension platform from a retracted position in which the extension platform is disposed within the subject support platform 106 and an extended position in which the extension platform extends outwardly from the subject support platform 106.

The first extension platform 502 and the second extension platform 504 may be made of any materials that are strong enough to provide support to the subject. For example, the extension platforms may be made from the same or similar materials as the subject support platform 106, or may be just a rigid material for providing support, such as an alloy, composite material, or plastic. In various embodiments, each extension platform may have a lip or other feature to prevent the extension platform from being slid too far into the subject support platform 106. Similarly, each extension platform may have another (or second) lip other feature to prevent the extension platform from being completely withdrawn from the subject support platform 106.

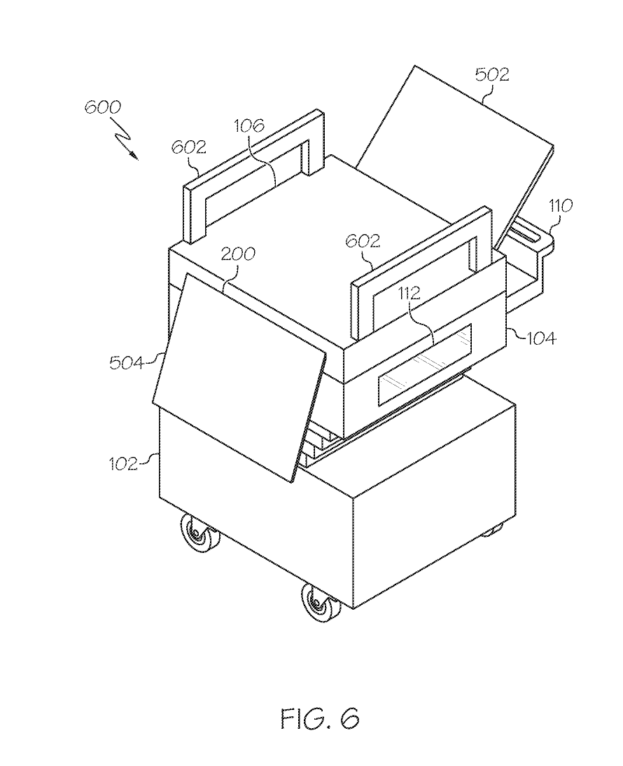

In various embodiments, the subject support platform 106 comprises a horizontal configuration in which the first extension platform 502 and the second extension platform 504 are substantially horizontal and a chair configuration in which the first extension platform 502 is inclined with respect to the subject support platform 106 and the second extension platform 506 is declined with respect to the subject support platform 106. Accordingly, in various embodiments, the first extension platform 502 and the second extension platform 504 are each rotatable with respect to the subject support platform 106, as shown in FIG. 6 such that the first extension platform 502 and the second extension platform 504 may be either inclined or declined with respect to the subject support platform 504. More particularly, the first extension platform 502 and the second extension platform 504 are rotatable from a substantially horizontal configuration (as shown in FIG. 5) to a chair configuration 600 (as shown in FIG. 6).

Rotation of the extension platforms may be achieved in any suitable way. In one example, the rail of slide assembly coupled to the extension platform may have a groove positioned near the end of the rail into which the bearing of the slide assembly may lock into place. When extended, the extension platforms may be substantially horizontal with respect to each other and to the subject support platform 106 such that the subject support platform 106 is in the horizontal configuration. Once locked into place, the bearing of the slide assembly may be rotated along an axis extending orthogonally to the direction in which the extension platform is extended from the subject support platform 106 to incline or decline the extension platform with respect to the subject support platform 106, thereby transitioning the subject support platform into the chair configuration. In some embodiments, when the bearing is locked into place within the slide assembly, it forms a hinge about which the extension platform may be rotated with respect to the subject support platform 106. In another example, the slide assembly coupled to the extension platform may include nested rails, one of which is fixed within the subject support platform 106 and another of which is attached to the extension platform. In this embodiment, the rail attached to the extension platform may have a rotational joint that enables the extension platform to be rotated about the joint with respect to the subject support platform 106.

Rotation of the first extension platform 502 and the second extension platform 504 may be manual, such as in embodiments in which a user rotates each extension platform to the desired position, or may be automatic, such as in embodiments in which the controller causes the extension platforms to be rotated into predetermined positions. In various embodiments, one or more actuators may be coupled to the extension platform to assist with rotation of the extension platform relative to the subject support platform 106. For example, an actuator may be removably coupled to the extension platform when the extension platform is in an extended position relative to the subject support platform 106. Other methods for rotating the extension platforms relative to the subject support platform 106 are contemplated to transition the subject support platform between a horizontal configuration and a chair configuration.

In various embodiments, the subject support platform 106 may be used in the horizontal configuration to transfer the subject from one support surface to another support surface (e.g., removing the subject from a support surface and/or placing the subject on a support surface), while the subject support platform 106 may be used in the chair configuration to support the subject, or during movement of the subject, such as from one room or facility to another room or facility. Alternatively, the subject support platform 106 may be used in the horizontal configuration for movement of the subject.

In some embodiments, the subject support platform 106 includes a pair of retractable side rails 602, as depicted in FIG. 6. Each of the side rails 602 includes a hinge assembly. The hinge assembly is configured to movably couple the side rail 602 to the subject support platform 106 and move the side rail 602 between a deployed position (depicted in FIG. 6) and a stowed position (not depicted). When the side rail 602 is in the deployed position, at least a portion of the side rail 602 is positioned above the subject support platform 106. When the side rail 602 is in the stowed position, the side rail 602 is positioned below at least the subject support surface of the subject support platform 106. For example, the side rails 602 may be retracted into the subject support platform 106 or stowed beneath the subject support platform 106. In some embodiments, the hinge assembly includes a locking mechanism (not shown) that is configured to maintain the side rail 602 in the deployed position and/or the stowed position.

Although described herein as being associated with the subject support platform 106, it is contemplated that in some embodiments, the retractable side rails 602 may be retractable into the base unit 104 instead of into the subject support platform 106. Other configurations are also contemplated.

In various embodiments, the subject transfer apparatus 100 is used to transfer a subject, as shown in FIGS. 7-9. For example, the subject transfer apparatus 100 may be used to transfer a subject 700 from a person support apparatus 10 to another patient support surface, such as an x-ray or surgical table. To use the subject transfer apparatus 100 to transfer the subject 700, the subject transfer apparatus 100 is positioned adjacent to a person support apparatus 10 upon which the subject 700 is disposed, as shown in FIG. 7. In embodiments, the subject support platform 106 of the subject transfer apparatus 100 is positioned adjacent to a central portion of the subject, including the subject's lower back, buttocks, and upper legs.

Next, the height of the subject support platform 106 is adjusted using the lifting mechanism such that the subject support platform 106 may be slid along a top surface of the person support apparatus 10. For example, a user may provide an input to the control system to cause the lifting mechanism to adjust the height of the subject support platform 106 relative to the base unit 102. As another example, the user may manually actuate the lifting mechanism to adjust the height of the subject support platform 106 relative to the base unit 102, such as by applying a force to the subject support platform 106 or otherwise actuating the lifting mechanism. In the embodiment depicted in FIG. 7, the lifting mechanism raises the subject support platform 106 in the direction of the arrow until a bottom surface of the subject support platform 106 is above a top surface of the person support apparatus 10, as shown in FIG. 8.

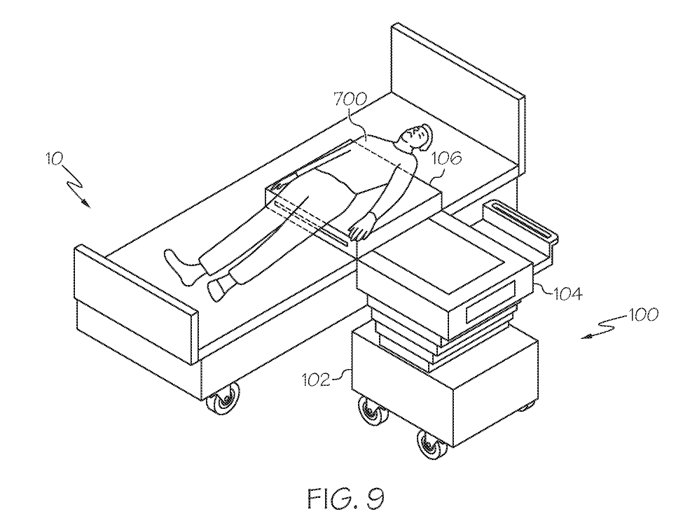

After the height of the subject support platform 106 has been adjusted, the subject support platform 106 is moved from the first position, as depicted in FIG. 8, to the second position, as depicted in FIG. 9. For example, a user may provide an input to the control system to cause the slide assembly coupled to the subject support platform 106 to move the subject support platform 106 from the first position to the second position. In the embodiment depicted in FIG. 8, the slide assembly moves the subject support platform 106 in the direction of the arrow until the subject support platform 106 is over a top surface of the person support apparatus 10, as shown in FIG. 9. As depicted in FIG. 9, when the subject support platform 106 is in the second position, it is disposed between the subject 700 and the person support apparatus 10.

In some embodiments, as the subject support platform 106 is moved from the first position to the second position, the subject 700 may be moved to enable the subject support platform 106 to be positioned between the subject 700 and the person support apparatus 10. For example, the subject 700 may be rotated at least partially on to his or her side to enable the subject support platform 106 to move between the subject 700 and the person support apparatus 10. Once the subject support platform 106 is at least partially beneath the subject 700, the subject 700 may be rolled back on to his or her back and disposed on the subject support platform 106.

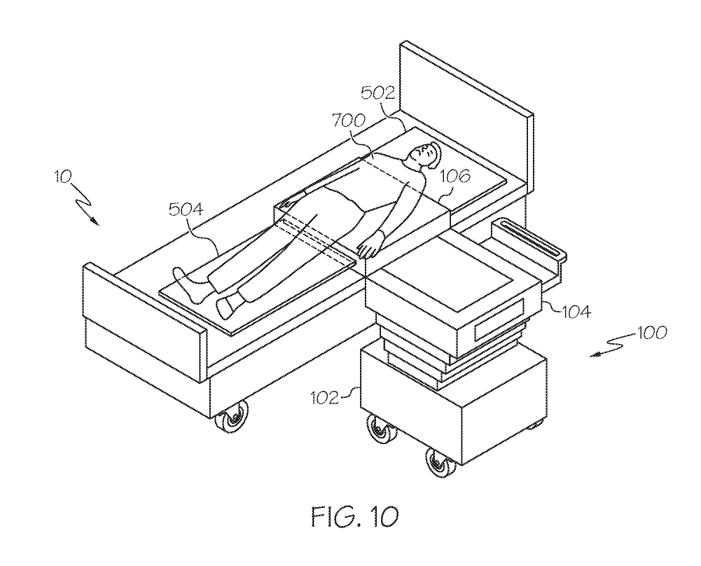

Once the subject support platform 106 is positioned between the subject 700 and the person support apparatus 10, as shown in FIG. 9, the first extension platform 502 and the second extension platform 504 are extended away from the subject support platform 106, as depicted in FIG. 10. For example, the first extension platform 502 and the second extension platform 504 may be extended from within the subject support platform 106 in directions opposite from one another, as depicted in FIG. 10. Extension of the platforms may be manual, or the extension platforms may be automatically extended from the subject support platform 106 in response to inputting a user input into the control system, as described hereinabove. In various embodiments, the first extension platform 502 and the second extension platform 504 are extended to provide support to the upper back, shoulders, and head of the subject 700, and the lower legs and feet of the subject 700, respectively.

In embodiments, after the first and second extension platforms are extended, the height of the subject support platform may be further adjusted. For example, the subject support platform 106 may be raised above top surface of the person support apparatus 10 to provide for additional clearance between the bottom side of the subject support platform 106 and the top surface of the person support apparatus 10. However, further adjustment of the height of the subject support platform 10 is optional.

Next, the subject support platform 106 is moved from the second position to the first position with the subject 700 disposed thereon. For example, a user may provide an input to the control system to cause the slide assembly coupled to the subject support platform 106 to move the subject support platform 106 from the second position to the first position.

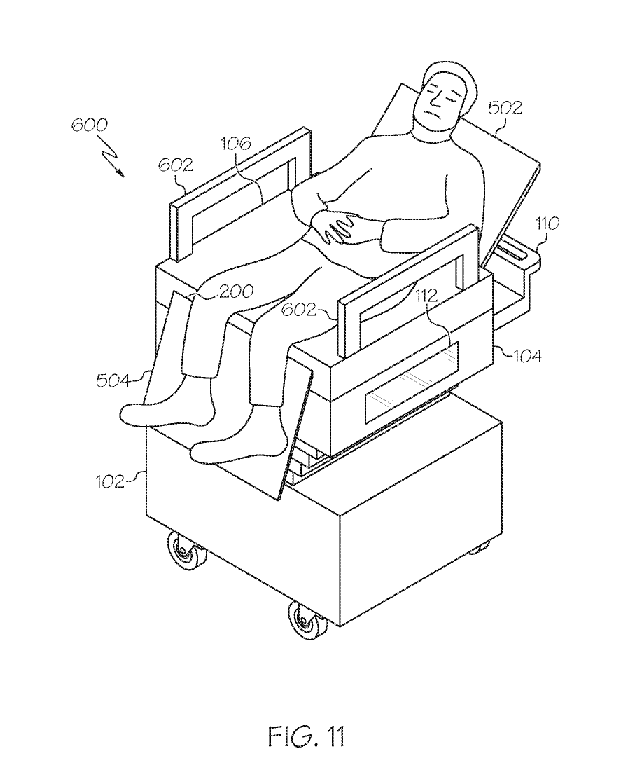

In embodiments in which the subject transfer apparatus 100 may be rotated into a chair configuration, such as the embodiment depicted in FIG. 6, the first extension platform 502 and the second extension platform 504 are rotated with respect to the subject support platform 106, as shown in FIG. 11. For example, a user input may be input into the control system coupled to the extension platforms to cause the extension platforms to be rotated from a substantially horizontal configuration into a chair configuration.

Various embodiments described herein include subject transfer apparatus for transferring a subject from a person support apparatus. The subject transfer apparatus may enable the subject to be transferred with less physical effort by a caregiver and/or less bodily contact between the caregiver and the subject than conventional transfer apparatuses. In various embodiments, the subject transfer apparatus may be reconfigured from a substantially horizontal configuration to a chair configuration for movement of the subject from one location to another.

Embodiments can be described with reference to the following numbered clauses, with preferred features laid out in the dependent clauses:

1. A subject transfer apparatus comprising a base unit comprising a lifting mechanism; a body unit coupled to the lifting mechanism; a subject support platform coupled to the body unit, wherein the subject support platform comprises a first extension platform and a second extension platform slidably disposed within the subject support platform, the first extension platform and the second extension platform are extendable away from the subject support platform in a opposite from one another; and a slide assembly coupling the subject support platform to the base unit such that the subject support platform is slidable between a first position in which the subject support platform is positioned over the base unit and a second position in which the subject support platform is cantilevered from the base unit.

2. The subject transfer apparatus according to clause 1, wherein the subject support platform is cantilevered from the base unit in a direction orthogonal to a direction in which the first extension platform is extended from the subject support platform.

3. The subject transfer apparatus according to clause 1 or 2, further comprising a pair of retractable side rails extending upward from the subject support platform and retractable into the subject support platform.

4. The subject transfer apparatus according to any preceding clause, wherein the first extension platform and the second extension platform are each rotatable with respect to the subject support platform.

5. The subject transfer apparatus according to any preceding clause, wherein the subject support platform comprises a horizontal configuration in which the first extension platform and the second extension platform are substantially horizontal and a chair configuration in which the first extension platform is declined with respect to the subject support platform and the second extension platform is inclined with respect to the subject support platform.

6. The subject transfer apparatus according to any preceding clause, further comprising a computing device configured to automatically control at least one of the lifting mechanism, the slide assembly, and the first and second extension platforms.

7. The subject transfer apparatus according to any preceding clause, wherein the slide assembly comprises one or more rails along which a bearing coupled to the subject support platform is slidable.

8. The subject transfer apparatus according to any preceding clause, wherein the slide assembly comprises an actuator.

9. The subject transfer apparatus according to any preceding clause, wherein the subject support platform provides a substantially continuous support surface along a length of the subject support platform and a width of the subject support platform.

10. A method of transferring a subject comprising positioning the subject transfer apparatus according to any preceding clause adjacent to a person support apparatus upon which the subject is disposed; adjusting a height of the subject support platform using the lifting mechanism such that the subject support platform may be slid along a top surface of the person support apparatus; moving the subject support platform from the first position to the second position, wherein when in the second position, the subject support platform is disposed between the subject and the person support apparatus; extending the first extension platform and the second extension platform away from the subject support platform; and moving the subject support platform from the second position to the first position with the subject disposed thereon.

11. A method of transferring a subject comprising positioning a subject transfer apparatus adjacent to a person support apparatus upon which the subject is disposed, the subject transfer apparatus comprising a base unit comprising a lifting mechanism; a body unit coupled to the lifting mechanism; a subject support platform coupled to the body unit, wherein the subject support platform comprises a first extension platform and a second extension platform slidably disposed within the subject support platform, the first extension platform and the second extension platform extendable away from the subject support platform opposite from one another; and a slide assembly coupling the subject support platform to the base unit such that the subject support platform is slidable between a first position in which the subject support platform is positioned over the base unit and a second position in which the subject support platform is cantilevered from the base unit; adjusting a height of the subject support platform using the lifting mechanism such that the subject support platform may be slid along a top surface of the person support apparatus; moving the subject support platform from the first position to the second position, wherein when in the second position, the subject support platform is disposed between the subject and the person support apparatus; extending the first extension platform and the second extension platform away from the subject support platform; and moving the subject support platform from the second position to the first position with the subject disposed thereon.

12. The method of transferring a subject according to clause 10 or 11, further comprising rotating the first extension platform and the second extension platform with respect to the subject support platform.

13. The method of transferring a subject according to any of clauses 10-12, wherein rotating the first extension platform and the second extension platform with respect to the subject support platform comprises inputting a user input into a control system coupled to the first extension platform and the second extension platform to cause the first extension platform and the second extension platform to be rotated.

14. The method of transferring a subject according to any of clauses 10-13, wherein rotating the first extension platform and the second extension platform comprises rotating the first extension platform and the second extension platform from a substantially horizontal configuration to a chair configuration.

15. The method of transferring a subject according to any of clauses 10-14, wherein adjusting the height of the subject support platform comprises inputting a user input into a control system coupled to the lifting mechanism to cause the lifting mechanism to adjust the height of the subject support platform.

16. The method of transferring a subject according to any of clauses 10-15, wherein moving the subject support platform from the first position to the second position comprises inputting a user input into a control system coupled to the slide assembly to cause the slide assembly to move the subject support platform from the first position to the second position.

17. The method of transferring a subject according to any of clauses 11-16, wherein the slide assembly comprises an actuator.

18. The method of transferring a subject according to any of clauses 11-17, wherein the subject support platform is cantilevered from the base unit in a direction orthogonal to a direction in which the first extension platform and the second extension platform are extended from the subject support platform.

19. The method of transferring a subject according to any of clauses 11-18, wherein the subject support platform provides continuous support along a length of the subject support platform and a width of the subject support platform.

20. A subject transfer apparatus comprising a base unit comprising a lifting mechanism; a body unit coupled to the lifting mechanism; a subject support platform coupled to the body unit providing a substantially continuous support surface along a length of the subject support platform and a width of the subject support platform, wherein the subject support platform comprises a first extension platform and a second extension platform slidably disposed within the subject support platform, the first extension platform and the second extension platform are extendable away from the subject support platform in a opposite from one another, and the first extension platform and the second extension platform are each rotatable with respect to the subject support platform; and a slide assembly coupling the subject support platform to the base unit such that the subject support platform is slidable between a first position in which the subject support platform is positioned over the base unit and a second position in which the subject support platform is cantilevered from the base unit.

21. The subject transfer apparatus according to clause 20, wherein the subject support platform is cantilevered from the base unit in a direction orthogonal to a direction in which the first extension platform is extended from the subject support platform.

22. The subject transfer apparatus according to clause 20 or 21, wherein the subject support platform comprises a horizontal configuration in which the first extension platform and the second extension platform are substantially horizontal and a chair configuration in which the first extension platform is inclined with respect to the subject support platform and the second extension platform in declined with respect to the subject support platform.

23. The subject transfer apparatus according to any of clauses 20-22, wherein the slide assembly comprises one or more rails along which a bearing coupled to the subject support platform is slidable.

24. The subject transfer apparatus according to any of clauses 20-23, further comprising a pair of retractable side rails extending upward from the subject support platform and retractable into the subject support platform.

25. A method of transferring a subject comprising positioning the subject transfer apparatus according to any of clauses 20-24 adjacent to a person support apparatus upon which the subject is disposed; adjusting a height of the subject support platform using the lifting mechanism such that the subject support platform may be slid along a top surface of the person support apparatus; moving the subject support platform from the first position to the second position, wherein when in the second position, the subject support platform is disposed between the subject and the person support apparatus; extending the first extension platform and the second extension platform away from the subject support platform; and moving the subject support platform from the second position to the first position with the subject disposed thereon.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A subject transfer apparatus comprising:
a base unit comprising a lifting mechanism;
a body unit coupled to the lifting mechanism;
a subject support platform coupled to the body unit, wherein the subject support platform comprises a first extension platform and a second extension platform slidably disposed within the subject support platform, the first extension platform and the second extension platform are extendable away from the subject support platform opposite from one another; and
a slide assembly coupling the subject support platform to the base unit such that the subject support platform is slidable between a first position in which the subject support platform is positioned over the base unit and a second position in which the subject support platform is cantilevered from the base unit.

2. The subject transfer apparatus according to claim 1, wherein the subject support platform is cantilevered from the base unit in a direction orthogonal to a direction in which the first extension platform is extended from the subject support platform.

3. The subject transfer apparatus according to claim 1, further comprising a pair of retractable side rails extending upward from the subject support platform and retractable into the subject support platform.

4. The subject transfer apparatus according to claim 1, wherein the first extension platform and the second extension platform are each rotatable with respect to the subject support platform.

5. The subject transfer apparatus according to claim 1, wherein the subject support platform comprises a horizontal configuration in which the first extension platform and the second extension platform are substantially horizontal and a chair configuration in which the first extension platform is inclined with respect to the subject support platform and the second extension platform in declined with respect to the subject support platform.

6. The subject transfer apparatus according to claim 1, further comprising a controller configured to automatically control at least one of the lifting mechanism, the slide assembly, and the first and second extension platforms.

7. The subject transfer apparatus according to claim 1, wherein the slide assembly comprises one or more rails along which a bearing coupled to the subject support platform is slidable.

8. The subject transfer apparatus according to claim 1, wherein the subject support platform provides a substantially continuous support surface along a length of the subject support platform and a width of the subject support platform.

9. A method of transferring a subject comprising:
positioning a subject transfer apparatus adjacent to a person support apparatus upon which the subject is disposed, the subject transfer apparatus comprising:
a base unit comprising a lifting mechanism;
a body unit coupled to the lifting mechanism;
a subject support platform coupled to the body unit, wherein the subject support platform comprises a first extension platform and a second extension platform slidably disposed within the subject support platform, the first extension platform and the second extension platform are extendable away from the subject support platform opposite from one another; and
a slide assembly coupling the subject support platform to the base unit such that the subject support platform is slidable between a first position in which the subject support platform is positioned over the base unit and a second position in which the subject support platform is cantilevered from the base unit;
adjusting a height of the subject support platform using the lifting mechanism such that the subject support platform may be slid along a top surface of the person support apparatus;
moving the subject support platform from the first position to the second position, wherein when in the second position, the subject support platform is disposed between the subject and the person support apparatus;
extending the first extension platform and the second extension platform away from the subject support platform; and
moving the subject support platform from the second position to the first position with the subject disposed thereon.

10. The method of transferring a subject according to claim 9, further comprising:
rotating the first extension platform and the second extension platform with respect to the subject support platform.

11. The method of transferring a subject according to claim 10, wherein rotating the first extension platform and the second extension platform with respect to the subject support platform comprises inputting a user input into a control system coupled to the first extension platform and the second extension platform to cause the first extension platform and the second extension platform to be rotated.

12. The method of transferring a subject according to claim 10, wherein rotating the first extension platform and the second extension platform comprises rotating the first extension platform and the second extension platform from a substantially horizontal configuration to a chair configuration.

13. The method of transferring a subject according to claim 9, wherein adjusting the height of the subject support platform comprises inputting a user input into a control system coupled to the lifting mechanism to cause the lifting mechanism to adjust the height of the subject support platform.

14. The method of transferring a subject according to claim 9, wherein moving the subject support platform from the first position to the second position comprises inputting a user input into a control system coupled to the slide assembly to cause the slide assembly to move the subject support platform from the first position to the second position.

15. The method of transferring a subject according to claim 9, wherein the subject support platform is cantilevered from the base unit in a direction orthogonal to a direction in which the first extension platform and the second extension platform are extended from the subject support platform.

16. The method of transferring a subject according to claim 9, wherein the subject support platform provides continuous support along a length of the subject support platform and a width of the subject support platform.

17. A subject transfer apparatus comprising:
a base unit comprising a lifting mechanism;
a body unit coupled to the lifting mechanism;
a subject support platform coupled to the body unit providing a substantially continuous support surface along a length of the subject support platform and a width of the subject support platform, wherein the subject support platform comprises a first extension platform and a second extension platform slidably disposed within the subject support platform, the first extension platform and the second extension platform are extendable away from the subject support platform opposite from one another, and the first extension platform and the second extension platform are each rotatable with respect to the subject support platform; and
a slide assembly coupling the subject support platform to the base unit such that the subject support platform is slidable between a first position in which the subject support platform is positioned over the base unit and a second position in which the subject support platform is cantilevered from the base unit.

18. The subject transfer apparatus according to claim 17, wherein the subject support platform is cantilevered from the base unit in a direction orthogonal to a direction in which the first extension platform is extended from the subject support platform.

19. The subject transfer apparatus according to claim 17, wherein the subject support platform comprises a horizontal configuration in which the first extension platform and the second extension platform are substantially horizontal and a chair configuration in which the first extension platform is inclined with respect to the subject support platform and the second extension platform in declined with respect to the subject support platform.

20. The subject transfer apparatus according to claim 17, wherein the slide assembly comprises one or more rails along which a bearing coupled to the subject support platform is slidable.
